(19) United States
(12) Patent Application Publication
(10) Pub. No.: US 2024/0338078 A1
(43) Pub. Date: Oct. 10, 2024

(54) TACTILE PRESENTATION DEVICE

(71) Applicant: TOYODA GOSEI CO., LTD., Kiyosu-shi, Aichi-ken (JP)

(72) Inventors: Takeshi FUJIWARA, Kiyosu-shi, Aichi-ken (JP); Yuji YONEHARA, Kiyosu-shi, Aichi-ken (JP); Tadatoshi KUROGI, Kiyosu-shi, Aichi-ken (JP)

(21) Appl. No.: 18/293,697

(22) PCT Filed: Sep. 9, 2021
(86) PCT No.: PCT/JP2021/033087

§ 371 Date: Jan. 30, 2024

(51) Int. Cl. G06F 3/01; G06F 3/04817; G06F 3/0484; G06F 3/0488

(52) U.S. Cl. CPC G06F 3/016; G06F 3/04817; G06F 3/0484; G06F 3/0488

(57) ABSTRACT

A tactile feedback apparatus includes a display unit that displays a visual object, a storage unit that stores waveform information expressing a tactile sensation of the visual object, a vibration actuator that provides a user with a tactile sensation based on vibration, and a waveform editing unit that edits the waveform information. The vibration actuator vibrates based on the waveform information in a case in which a targeted area of the user's body for the tactile feedback by the vibration actuator comes into contact with the visual object. The waveform editing unit updates the waveform information stored in the storage unit based on an operation associated with completion of the editing.

### TECHNICAL FIELD

The present invention relates to a tactile feedback apparatus.

### BACKGROUND ART

Research is being conducted to apply tactile feedback apparatuses, which provide users with tactile sensations, in various technological fields such as interactive computer applications, remote robotic engineering, entertainment, and medicine. A tactile feedback apparatus enables users to perceive intended tactile sensations through application of stimuli such as vibrations.

The tactile sensation provided to the user from a tactile feedback apparatus needs to have a minimal deviation from the user's concept of the tactile sensation. Patent Literature 1 discloses a method for reducing the aforementioned deviation by using visual information such as text or visual objects to express a tactile sensation desired to be expressed, thereby sharing that tactile sensation in a way other than actually experiencing it. For example, while sharing a tactile sensation using the above-described method with a creator, who conceptualizes the tactile sensation, a reproducer generates a control signal for reproducing the tactile sensation in accordance with the intentions of the creator.

### CITATION LIST

### Patent Literature

Patent Literature 1: Japanese Laid-Open Patent Publication No. 2021-26618

### SUMMARY OF INVENTION

### Technical Problem

It is difficult to accurately express one's own concept of tactile sensation through visual information such as text or visual objects. Therefore, it is necessary to edit the control signal of tactile sensation, which has been created based on visual information, to bring the control signal closer to the imagined tactile sensation. The technique of Patent Literature 1 has room for improvement in the operation of editing a control signal of tactile sensation.

### Solution to Problem

In one aspect, a tactile feedback apparatus includes a display unit that displays a visual object, a storage unit that stores waveform information expressing a tactile sensation of the visual object a vibration actuator that provides a user with a tactile sensation based on vibration, and a waveform editing unit that edits the waveform information. The vibration actuator vibrates based on the waveform information in a case in which a targeted area of the user's body for the tactile feedback by the vibration actuator comes into contact with the visual object. The waveform editing unit updates the waveform information stored in the storage unit based on an operation associated with completion of the editing.

The above-described configuration allows the user to edit the waveform information, which expresses the tactile sensation of the visual object displayed by the display unit, while comparing it with the tactile sensation imagined based on the visual information obtained from the visual object. This allows the user to instinctively and intuitively edit the waveform information, which coordinates visual and tactile sensations. In the field of neuroscience, it is believed that the processing of vision and touch occurs in an inseparable domain. Therefore, the ability to edit the waveform information while coordinating visual and tactile sensations is significantly effective in creating a waveform information that expresses a tactile sensation matching the user's imagined tactile sensation.

In one aspect, the above-described tactile feedback apparatus includes a display control unit that changes an appearance of the visual object. The waveform information is one of multiple sets of waveform information stored in the storage unit. Each set of the waveform information independently corresponds to different appearance of the visual object.

In one aspect, the storage unit of the above-described tactile feedback apparatus stores accumulated information including differential information related to differences between the updated waveform information and preset waveform information, or accumulated information of the updated waveform information.

In one aspect, the display unit of the above-described tactile feedback apparatus displays an editing icon for editing the waveform information on a screen on which the visual object is displayed. The waveform editing unit edits the waveform information based on an operation of the editing icon.

In one aspect, the display unit of the above-described tactile feedback tactile feedback apparatus includes a comment processing unit for inputting and storing a user's comment on the provided tactile sensation.

### BRIEF DESCRIPTION OF DRAWINGS

FIG. 1 is a block diagram of a tactile feedback apparatus.

FIG. 2 is a plan view illustrating a wearable device, a display unit, and an input device of the tactile feedback apparatus.

FIG. 3 is a cross-sectional view taken along line 3-3 in FIG. 2.

### DESCRIPTION OF EMBODIMENTS

A tactile feedback apparatus according to one embodiment will now be described.

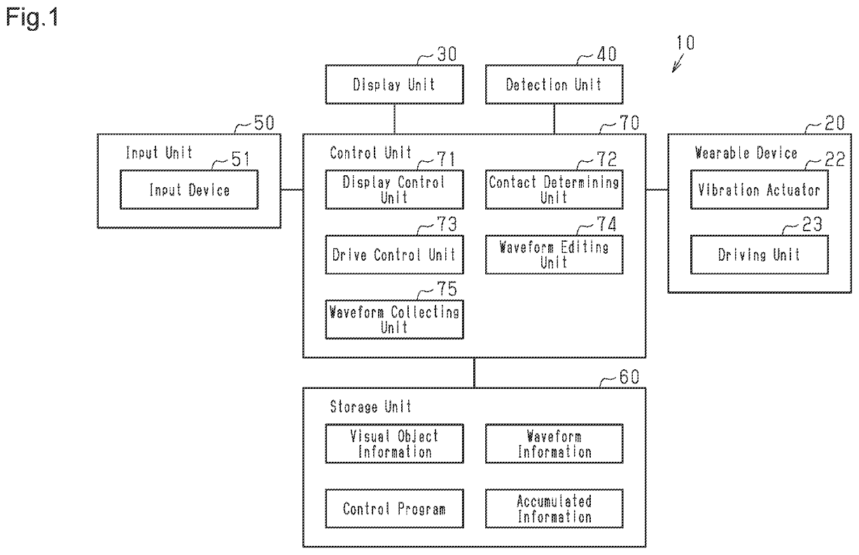

As illustrated in FIGS. 1 to 3, a tactile feedback apparatus 10 includes a wearable device 20, a display unit 30, a detection unit 40, an input unit 50, a storage unit 60, and a control unit 70.

### Wearable Device

As shown in FIGS. 1 to 3, the wearable device 20 is a tactile feedback device that is attached to a fingertip of a user's hand. The targeted area for the tactile feedback is the pad of a finger. The wearable device 20 includes a band-shaped base 21, which is attachable to the user's finger A by being wound around the finger A. The base 21 is made of a soft material that can be curved, and expand or contract in any planar direction. The soft materials used for the base 21 include an elastomer such as silicone and urethane, and a stretch fabric.

A vibration actuator 22 is disposed on the inner surface of the base 21. The vibration actuator 22 is, for example, a sheet-shaped dielectric elastomer actuator (DEA). Although not illustrated, a holding portion for holding the base 21 in a state of being wound around the finger A is provided on the inner surface or the outer surface of the base 21. The holding portion is not particularly limited, and a typical configuration used for holding a band-shaped member such as a hook-and-loop fastener can be used.

The DEA is a multilayer structure including sheet-shaped dielectric layers each made of a dielectric elastomer, positive electrode layers, and negative electrode layers. One of the positive electrode layers and one of the negative electrode layers are arranged on opposite sides of corresponding one of the dielectric layers in the thickness direction. An insulating layer is laminated on the outermost layer of the DEA. In the DEA, when direct-current voltage is applied across the positive electrode and the negative electrode, the dielectric layer is deformed so as to be compressed in the thickness direction and to be extended in the planar direction of the DEA, which is a direction along the plane of the dielectric layer, in accordance with the magnitude of the applied voltage. The DEA causes the user to recognize vibration or the like based on expansion and contraction of the DEA as a tactile sensation.

The dielectric elastomer of the dielectric layer is not particularly limited, and a dielectric elastomer used in a typical DEA can be used. The dielectric elastomer may be, for example, crosslinked polyrotaxane, silicone elastomer, acrylic elastomer, or urethane elastomer. Further, one of these types of dielectric elastomer may be used alone, or two or more of these may be used in combination. The thickness of the dielectric layers is, for example, 20 to 200 μm.

The materials for the positive electrode layer and the negative electrode layer include, for example, conductive elastomer, carbon nanotubes, Ketjen black (registered trademark), and vapor-deposited metal films. The conductive elastomer includes, for example, a conductive elastomer that contains an insulating polymer and a conductive filler.

The insulating polymer includes, for example, a crosslinked polyrotaxane, silicone elastomer, acrylic elastomer, or urethane elastomer. One of these types of insulating polymer may be used alone, or two or more of these may be used in combination. The conductive filler may be, for example, carbon nanotubes, Ketjen black (registered trademark), carbon black, or metal particles of copper, silver, or the like. One of these types of conductive filler may be used alone, or two or more of these may be used in combination. The thicknesses of the positive electrode and the negative electrode are, for example, 1 to 100 μm.

The insulating elastomer forming the insulating layer is not particularly limited, and may be a typical insulating elastomer that is used for the insulating portion of a typical DEA. The insulating elastomer may be, for example, crosslinked polyrotaxane, silicone elastomer, acrylic elastomer, and urethane elastomer. Further, one of these types of insulating elastomer may be used alone, or two or more of these may be used in combination. The thickness of the insulating layer is, for example, 10 to 100 μm. Furthermore, the overall thickness of the DEA, from the perspective of ensuring flexibility and strength, is preferably, for example, 0.3 to 3 mm.

As shown in FIG. 1, the wearable device 20 includes a driving unit 23 that applies a voltage from a power source (not shown), such as a battery, across two electrodes, which are the positive electrode and the negative electrode of the vibration actuator 22.

### Display Unit

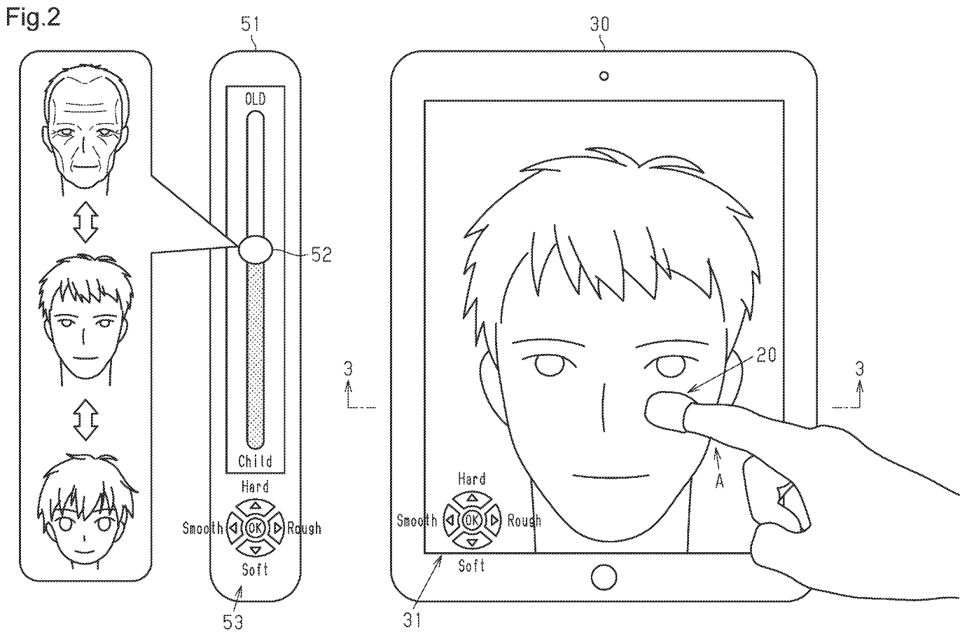

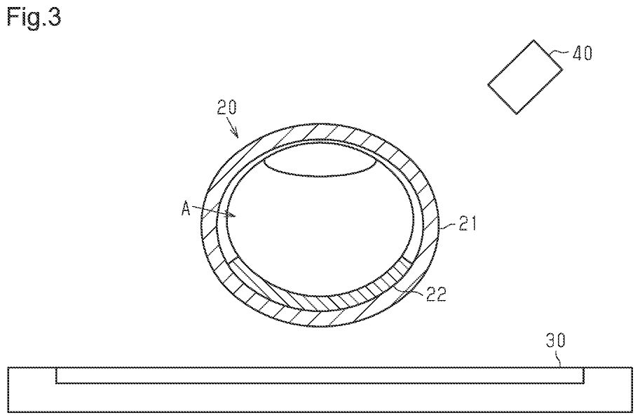

As shown in FIGS. 1 to 3, the display unit 30 is a display device that displays visual objects that are visible to the user. The image of the visual object displayed by the display unit 30 may be a two-dimensional image or a three-dimensional image such as a holographic image. Examples of the display unit 30 include head-worn type display devices such as a head-mounted display and augmented reality glasses, non-head-worn display devices such as the display of a tablet terminal or a mobile terminal or an installation-type display, and a projector that forms an image on a space or an object. FIGS. 2 and 3 illustrate a case in which the display unit 30 is a display of a tablet terminal as an example.

The visual object displayed on the display unit 30 represents an object for which a tactile sensation is desired to be expressed through the wearable device 20. Examples of the visual object include animals such as humans and pets, foods such as vegetables and fruits, and inanimate objects such as furniture and machines. In the present embodiment, as an example, a case in which a human face is set as a visual object will be described.

As shown in FIG. 2, the display unit 30 displays an editing icon 31 used for waveform editing, which will be described later, together with a visual object. The editing icon 31 is displayed on the same screen as the visual object. In addition, it is preferable that the editing icon 31 be displayed at a position where at least a part of the editing icon 31 overlaps with the visual object.

### Detection Unit

As shown in FIGS. 1 and 3, the detection unit 40 detects the position of the pad of the finger A, which is the targeted area for the tactile feedback provided by the wearable device 20. Examples of the detection unit 40 include a conventional motion capture device of an optical type, a mechanical type, a magnetic type, and a contact sensor such as a touch screen mounted on the display surface of the display unit 30. In a case in which the display unit 30 is a head-worn type display device, the position of the pad of the finger A may be detected based on movement calculation information of the coordinates (XYZ coordinates) of the finger A acquired by the head-worn type display device. In this case, the head-worn type display device serves as the detection unit 40.

### Input Unit

As shown in FIGS. 1 and 2, the input unit 50 receives operation instructions and the like from the user. Examples of the input unit 50 include a keyboard, a touch screen, and a mouse. In addition, the input unit 50 of the present embodiment includes an input device 51 that includes a dedicated external device. The input device 51 includes a slider 52 for changing the appearance of the visual object displayed on the display unit 30 and editing buttons 53 used for waveform editing, which will be discussed below.

### Storage Unit

As shown in FIG. 1, the storage unit 60 stores visual object information, waveform information, a control program, and accumulated information. The storage unit 60 is, for example, a nonvolatile memory.

The visual object information is an image of the visual object displayed on the display unit 30. The visual object information includes multiple images having different appearances for the same visual object. Examples of the multiple images having different appearances include images before and after aging, and images before and after a specific process. Examples of the images before and after aging include images whose appearances vary due to aging, such as images of the same person during their childhood, young adulthood, prime of life, middle age, and old age. Further, in a case in which the visual object is a food such as a fruit, images having different degrees of ripeness may be used. In a case in which the visual object is an inanimate object such as a piece of furniture or a machine, images showing different material textures due to aging may be used. Examples of the images before and after a specific process include images of skin before using cosmetics and images of skin after continuous use of the cosmetics for a certain period. Examples of the images before and after a specific process include images before and after a process of moistening a surface. Hereinafter, a case will be described in which multiple images data included in visual object information are images of the same person whose appearance varies due to aging.

The waveform information is a voltage waveform for driving the vibration actuator 22 so as to express the tactile sensation of the visual object displayed on the display unit 30. The waveform information is independently set for each of the areas expected to have different tactile sensations for each of the respective images having different appearances. Each set of the waveform information is stored in the storage unit 60 in association with both the image of the corresponding appearance and the corresponding area in the image of that appearance. For example, a set of waveform information corresponding to the cheeks, a set of waveform information corresponding to the forehead, and a set of waveform information corresponding to the jaw are set for each of the images of childhood, prime age, and old age.

Further, each set of the waveform information includes XY-direction waveform information and Z-direction waveform information. The XY-direction waveform information is waveform data expressing a tactile sensation when the finger A in contact with the surface of the visual object displayed on the display unit 30 is moved along the surface. The XY-direction waveform information is, for example, a voltage waveform for driving the vibration actuator 22 so as to express a tactile sensation including surface roughness.

The Z-direction waveform information is waveform data expressing a tactile sensation when the finger A is moved to be pressed against or separated from the surface of the visual object displayed on the display unit 30. The Z-direction waveform information is, for example, a voltage waveform for driving the vibration actuator 22 so as to express a tactile sensation including hardness or stickiness of the surface.

The waveform information stored in the storage unit 60 is preset waveform information that is pre-configured before any user editing. Once edited by the user, the waveform information is updated to the edited waveform information. The editing and updating of the waveform information will be discussed below.

### Control Unit

The control unit 70 includes a display control unit 71, a contact determining unit 72, a drive control unit 73, a waveform editing unit 74, and a waveform collecting unit 75. The control unit 70 may be circuitry including: 1) one or more processors that operate according to a computer program (software); 2) one or more dedicated hardware circuits (application specific integrated circuits: ASIC) that execute at least part of various processes; or 3) a combination thereof. The processors include, for example, CPUs.

The display control unit 71 executes a process of causing the display unit 30 to display an image of a visual object based on a user's operation on the input unit 50. This process is executed using the control program stored in the storage unit 60. The display control unit 71 also executes a process of changing the appearance of the image of the visual object displayed on the display unit 30 based on a user's operation of moving the slider 52 of the input device 51.

Based on a detection result of the detection unit 40, the contact determining unit 72 executes a process of determining whether the pad of the finger A, which is the targeted area for the tactile feedback by the wearable device 20, is in contact with the visual object displayed on the display unit 30. In addition, based on the detection result of the detection unit 40, the contact determining unit 72 executes a process of determining the area of the visual object with which the pad of the user's finger A is in contact, and a process of determining the moving direction of the user's finger A in contact with the visual object. These processes are executed using the control program stored in the storage unit 60. The moving direction includes an XY-direction, which is a direction along the surface of the visual object, a Z-direction, which is a direction orthogonal to the surface of the visual object, and both of these directions.

Based on the determination result of the contact determining unit 72, the drive control unit 73 obtains, from the storage unit 60, waveform information that corresponds to the area of the image of the visual object with which the pad of the user's finger A is in contact, and the moving direction of the user's finger A. Next, the drive control unit 73 executes a process of controlling the driving unit 23 such that a voltage having the waveform based on the obtained waveform information is applied to vibration actuator 22. These processes are executed using the control program stored in the storage unit 60.

The waveform editing unit 74 edits and updates the waveform information stored in the storage unit 60. When the process of driving the vibration actuator 22 is executed, the waveform editing unit 74 generates editable waveform information, which is obtained by duplicating the waveform information used for driving the vibration actuator 22. The waveform editing unit 74 edits the editable waveform information based on a user's operation on the input unit 50, and updates the waveform information stored in the storage unit 60 with the edited editable waveform information.

A case will now be described in which, as an operation on the input unit 50, the user operates the left button (smooth) or the right button (rough) of the editing icon 31 displayed on the display unit 30 or the editing button 53 of the input device 51. In this case, the waveform editing unit 74 changes editable waveform information obtained by duplicating the XY-direction waveform information, based on the user's operation. For example, when the left button (smooth) is operated, the frequency is increased so as to obtain a voltage waveform that provides a smoother tactile sensation. When the right button (rough) is operated, the frequency is decreased so as to obtain a voltage waveform that provides a rougher tactile sensation. The degree to which the frequency is changed is increased stepwise in accordance with, for example, the number of times the left button (smooth) or the right button (rough) is operated or the time during which the left button or the right button is held down.

A case will now be described in which the user operates the editing icon 31 displayed on the display unit 30 or the up button (hard) or the down button (soft) in the editing button 53 of the input device 51. In this case, the waveform editing unit 74 changes editable waveform information obtained by duplicating the voltage waveform of the Z-direction waveform information, based on the user's operation. For example, when the up button (hard) is operated, the waveform editing unit 74 increases the slope of the rise of the voltage so as to obtain a voltage waveform that provides a harder tactile sensation. When the down button (soft) is operated, the waveform editing unit 74 reduces the slope of the rise of the voltage so as to obtain a voltage waveform that provides a softer tactile sensation. The degree to which the slope of the rise of the voltage is changed is increased stepwise in accordance with, for example, the number of times the up button (hard) or the lower button (soft) is operated, or the time for which the up button or the lower button is held down.

A case will now be described in which the user operates the editing icon 31 displayed on the display unit 30 or the center button (OK) in the editing button 53 of the input device 51. In this case, the waveform editing unit 74 updates the waveform information stored in the storage unit 60 using the changed editable waveform information, and deletes the editable waveform information. In the present embodiment, the operation on the center button (OK) corresponds to the operation of completing editing.

When the user touches a portion corresponding to the editable waveform information during the editing of the waveform information, that is, in a state in which the editable waveform information is being created, the drive control unit 73 controls the driving unit 23 using the editable waveform information so as to drive the vibration actuator 22. These processes are executed using the control program stored in the storage unit 60.

Each time the waveform information stored in the storage unit 60 is updated, the waveform collecting unit 75 obtains differential information related to the difference between the updated waveform information and preset waveform information, and accumulates and stores the obtained differential information as accumulated information in the storage unit 60. The processes by the waveform collecting unit 75 are executed using the control program stored in the storage unit 60.

Next, a method for editing the voltage waveform used to operate the vibration actuator 22 with the tactile feedback apparatus 10 of the present embodiment will be described. The editing is performed such that the tactile sensation provided to the user closely matches the imagined tactile sensation that the user has.

First, the user operates the input unit 50 or the input device 51 to display an image of a desired visual object on the display unit 30. In addition, the user attaches the wearable device 20 onto the finger A so that the vibration actuator 22 is positioned on the pad of the finger A. Next, the user brings the pad of the finger A, wearing the wearable device 20, into contact with a specific area of the visual object displayed by the display unit 30 and moves the finger A in contact with the specific portion in the XY-direction along the surface of the visual object and in the Z-direction, which is orthogonal to the surface of the visual object. Hereinafter, this operation is referred to as a contact operation.

At this time, based on the detection result of the detection unit 40 and the determination result of the contact determining unit 72, a voltage is applied to the vibration actuator 22. The voltage has a waveform based on waveform information corresponding to the area of the visual object with which the pad of the user's finger A is in contact and the moving direction of the user's finger A. This causes the vibration actuator 22 to vibrate, providing the user's finger A with a tactile sensation based on the vibration of the vibration actuator 22.

The user compares the user's imagined tactile sensation based on the image of the visual object displayed by the display unit 30 with the tactile sensation provided based on the vibration of the vibration actuator 22. Then, the user performs an operation of adjusting the editable waveform information by operating the up button (hard), the down button (soft), the left button (smooth), and the right button (rough) so as to eliminate the deviation between the imagined tactile sensation and the provided tactile sensation. Hereinafter, this operation will be referred to as an adjustment operation.

When the user performs a contact action again after the adjustment operation, the tactile sensation based on the adjusted editable waveform information is provided to the user. Thereafter, the user compares the imagined tactile sensation and the provided tactile sensation. In this manner, the user repeatedly performs the adjustment operation, the contact action, and the comparison between the imagined tactile sensation and the provided tactile sensation. Then, when the imagined tactile sensation and the provided tactile sensation agree with each other, the user operates the center button (OK) to update the waveform information stored in the storage unit 60 using the editable waveform information.

The user performs the above-described series of processes of the adjustment operation for each area of the image of the visual object displayed by the display unit 30. Then, the user operates the slider 52 of the input device 51 to change the appearance of the visual object displayed by the display unit 30, and performs the same adjustment operation on the image of the changed visual object. As a result, waveform information for driving the vibration actuator 22 so as to provide a tactile sensation that is closer to the tactile sensation imagined based on the visual information is obtained for the visual object displayed by the display unit 30.

The editing of the waveform information using the tactile feedback apparatus 10 according to the present embodiment can be employed in, for example, the creation of a tactile sample used when communicating a change in the tactile sensation before and after the use of cosmetics, and the creation of a tactile sensation used as an element of a texture given to a visual object created by a VR technique.

Operation and advantages of the present embodiment will now be described.

(1) The tactile feedback apparatus 10 includes the display unit 30, which displays a visual object, the storage unit 60, which stores waveform information expressing a tactile sensation of the visual object, the vibration actuator 22, which is worn by the user, and the waveform editing unit 74, which edits the waveform information. The vibration actuator 22 vibrates based on the waveform information when the pad of the finger A, which is the targeted area of the user's body for the tactile feedback by the vibration actuator 22, comes into contact with the visual object. The waveform editing unit 74 updates the waveform information stored in the storage unit 60 based on the operation associated with the completion of the editing.

The above-described configuration allows the user to edit the waveform information, which expresses the tactile sensation of the visual object displayed by the display unit 30, while comparing it with the tactile sensation imagined based on the visual information obtained from the visual object. This allows the user to instinctively and intuitively edit the waveform information, which coordinates visual and tactile sensations. In the field of neuroscience, it is believed that the processing of vision and touch occurs in an inseparable domain. Therefore, the ability to edit the waveform information while coordinating visual and tactile sensations is significantly effective in creating a waveform information that expresses a tactile sensation matching the user's imagined tactile sensation.

(2) During the editing of the waveform information, the drive control unit 73 drives the vibration actuator 22 based on the editable waveform information, which is being edited.

According to the above-described configuration, when the editable waveform information is changed, the tactile sensation provided by the vibration of the vibration actuator 22 is switched to the tactile sensation based on the changed editable waveform information without performing an operation such as storing of the changed editable waveform information. Accordingly, it is possible to smoothly perform the operation of searching for the waveform information for causing the vibration actuator 22 to vibrate so as to provide a specific tactile sensation while editing the editable waveform information.

(3) The tactile feedback apparatus 10 includes the display control unit 71, which changes the appearance of the visual object displayed by the display unit 30. The storage unit 60 stores pieces of waveform information, each of which independently corresponds to a different appearance of the visual object.

The above-described configuration can continuously show, to the user, the states before and after the appearance of the visual object is changed. This allows for the materialization of a tactile sensation that the user has imagined based on visual information. For example, when the user edits the waveform information of the tactile sensation of the person in an image representing young adulthood, the user imagines a tactile sensation representing childhood by looking at an image representing childhood. Subsequently, when the user looks at an image representing young adulthood and imagines a tactile sensation representing that period, a tactile sensation representing childhood serves as a point of comparison, allowing for a more concrete imagination of a tactile sensation representing young adulthood. As the tactile sensation that the user has imagined based on the visual information becomes more specific, the waveform information obtained through editing becomes data capable of expressing a tactile sensation close to the tactile sensation imagined by the user.

(4) The storage unit 60 stores accumulated information including differential information related to differences between the updated waveform information and a preset waveform information.

There are individual differences in tactile sensations that users imagine based on visual information. When tactile sensation that users imagine based on visual information are different, the waveform information to be edited is also different. Therefore, the accumulated information accumulated by having multiple different users to perform the waveform editing is a collection of information indicating individual differences. Such accumulated information is useful, for example, when searching for a range of general-purpose waveform information accepted by majority of users, and when quantitatively analyzing the individual differences. Particularly, when combined with the above-described configuration (3), the screen transition controlled by the display control unit 71 can be used as a preferable screen transition for accumulating and quantitatively analyzing the waveform information and the individual differences in waveform information.

(5) The display unit 30 displays the editing icon 31 used to edit the waveform information on the screen on which a visual object is displayed. The waveform editing unit 74 edits the waveform information based on operation on the editing icon 31.

The above-described configuration allows the user to intuitively perform operation for editing the waveform information.

(6) The tactile feedback apparatus 10 includes the input device 51, which has the editing button 53 used to edit waveforms.

The above-described configuration allows the user to edit waveform information via the input device 51 with the hand opposite to the hand to which the wearable device 20 is attached. Accordingly, the user can smoothly perform the contact operation with the hand wearing the wearable device 20 and edit the waveform information with the input device 51.

The above-described embodiment may be modified as follows. The above-described embodiment and the following modifications can be combined as long as the combined modifications remain technically consistent with each other.

The targeted area for the tactile feedback by the wearable device 20 is not limited to the pad of a finger, but may be any other area such as a palm.

The configuration of the base 21 of the wearable device 20 is not particularly limited, and may be any configuration as long as the vibration actuator 22 can be held in contact with the targeted area for the tactile feedback.

The vibration actuator 22 does not necessarily need to be configured to be attached to the user. For example, the vibration actuator 22 may be disposed on the back of the screen of the display unit 30, on which a visual object is displayed. Examples of the display unit 30 with the vibration actuator 22 include known display devices including a touch interface, such as a smartphone and a tablet terminal. In this case, the display device is employed as the tactile feedback apparatus 10. In this case, the above-described screen transition is performed on the screen of the display device based on a user's operation. Vibration of the vibration actuator 22 is transmitted to the user who touches the screen via the screen of the display device, so that the tactile sensation based on the vibration is provided to the user.

A comment processing unit for inputting and storing a user's comment on the provided tactile sensation may be provided. The comment processing unit causes the display unit 30 to display an input icon for inputting users' comments. The user can freely input a comment on the provided tactile sensation by operating the input icon. For example, when the provided tactile sensation is close to the user's imagination for the tactile sensation, the user inputs comments like “I like this” or “This is my preferred tactile sensation” on the input icon. Additionally, if the user recognizes that the provided tactile sensation is different from what the user imagined, the user inputs “This tactile sensation is a different tactile sensation A” to the input icon.

Further, the comment processing unit stores the input comments in the storage unit 60. The comment processing unit stores the input comments in the storage unit 60 as comment information, or edits the comment information in the storage unit 60 based on input comments. Since the comment information is detailed psychological information of the user regarding the provided tactile sensation, the comment information is useful as qualitative evaluation information of the provided tactile sensation. Therefore, the comment processing unit allows qualitative evaluation information to be acquired in addition to quantitative evaluation information based on the editing icon 31 with respect to the waveform information corresponding to the provided tactile sensation. The method of inputting comments by the user is not particularly limited. Examples of the comment inputting method include text input through typing, voice input, input through image recognition, and input through selecting from preset options.

The vibration actuator 22 is not limited to a DEA, but may be a typical vibration actuator used in a tactile feedback apparatus. Examples of typical vibration actuators include other types of electroactive polymer actuators (EPA) such as an ionic polymer metal composite (IPMC), an eccentric motor, a linear resonant actuator, a voice coil actuator, and a piezoelectric actuator.

Instead of the configuration of editing the waveform information obtained by duplicating the waveform information stored in the storage unit 60, the waveform information stored in the storage unit 60 may be directly edited and updated.

The accumulated information may be obtained by accumulating the updated waveform information.

A tactile feedback system may be provided that is equipped with the tactile feedback apparatus 10 and a storage unit provided on a server or in cloud storage. The system may be configured to store accumulated information in the storage unit provided on the server or in cloud storage. In this case, the tactile feedback apparatus 10 includes a transmitting unit (transmission circuit) that transmits the accumulated information.

The waveform information may include only one of the XY-direction waveform information and the Z-direction waveform information.

The display position of the editing icon 31 on the screen on which the visual object is displayed may be changed. Further, one of the editing icon 31 or the editing buttons 53 of the input device 51 may be omitted.

An appearance changing icon for changing the appearance of the visual object displayed on the display unit 30 may be displayed on the screen on which the visual object is displayed. In this case, the input device 51 may be omitted.

1. A tactile feedback apparatus, comprising:
a display unit that displays a visual object;
a storage unit that stores waveform information expressing a tactile sensation of the visual object;
a vibration actuator that provides a user with a tactile sensation based on vibration; and
a waveform editing unit that edits the waveform information, wherein
the vibration actuator vibrates based on the waveform information in a case in which a targeted area of the user's body for the tactile feedback by the vibration actuator comes into contact with the visual object, and
the waveform editing unit updates the waveform information stored in the storage unit based on an operation associated with completion of the editing.

2. The tactile feedback apparatus according to claim 1, further comprising a display control unit that changes an appearance of the visual object,
wherein the waveform information is one of multiple sets of waveform information stored in the storage unit, each set of the waveform information independently corresponding to different appearance of the visual object.

3. The tactile feedback apparatus according to claim 1, wherein the storage unit stores
accumulated information including differential information related to differences between the updated waveform information and preset waveform information, or
accumulated information of the updated waveform information.

4. The tactile feedback apparatus according to claim 1, wherein
the display unit displays an editing icon for editing the waveform information on a screen on which the visual object is displayed, and
the waveform editing unit edits the waveform information based on an operation of the editing icon.

5. The tactile feedback tactile feedback apparatus according to claim 1, further comprising a comment processing unit for inputting and storing a user's comment on the provided tactile sensation.
